(19) United States
(12) Patent Application Publication
(10) Pub. No.: US 2026/0365084 A1
(43) Pub. Date: Nov. 19, 2026

(54) ADJUSTMENT MECHANISM FOR VEHICLE SEAT AND VEHICLE SEAT COMPRISING THE ADJUSTMENT MECHANISM

(71) Applicant: FAURECIA Sièges d'Automobile, NANTERRE (FR)

(72) Inventors: Nicolas NAVATTE, CONDÉ SUR NOIREAU (FR); Yves BOURVEN, THURY-HARCOURT (FR); Nicolas VAZEILLE, BRIOUZE (FR)

(21) Appl. No.: 19/676,139

(22) Filed: May 13, 2026

(30) Foreign Application Priority Data
May 14, 2025 (FR) 2505125

(51) Int. Cl. B60N 2/07

(52) U.S. Cl. CPC B60N 2/0722

(57) ABSTRACT

An adjustment mechanism for a vehicle seat comprising a housing comprising a first counter-guide element, an eccentric device rotatably mounted about a main axis of rotation in the housing, the eccentric device comprises an eccentric shaft, an orbital gear rotatably mounted on the eccentric shaft, an output device comprising a toothed ring which cooperates with the orbital gear, a slide guided in translation with respect to the housing in a first sliding direction and in translation with respect to the orbital gear in a second sliding direction, the slide further comprises an additional second radial guide element with an additional contact surface and the orbital gear comprises an additional second counter-guide element.

### PRIORITY CLAIM

This application claims priority to French Patent Application FR2505125, filed May 14, 2025, which is expressly incorporated by reference herein.

### BACKGROUND

The present disclosure relates to a mechanism for a vehicle seat, particularly a motor vehicle seat. The present disclosure also relates to a motor vehicle seat comprising the adjustment mechanism.

### SUMMARY

According to the present disclosure, vehicle seats may use a reducer to adjust the seat, to reduce the effort required from a user, or to reduce the adjustment speed and power required when an actuator is used. The vehicle seat includes:
a housing comprising a first counter-guide element,
an eccentric device rotatably mounted about a main axis of rotation in the housing, the main axis of rotation extending in an axial direction, the eccentric device comprises an eccentric shaft,
an orbital gear mounted on the eccentric shaft for rotation about an eccentric axis, the eccentric axis extending in the axial direction and being spaced from the main axis of rotation by a (non-zero) eccentricity distance, the orbital gear comprising two second counter-guide elements, the second counter-guide elements being diametrically opposed with respect to the eccentric axis,
an output device comprising a toothed ring which cooperates (meshes) with the orbital gear,
a slide comprising a first radial guide element and two second radial guide elements, the first radial guide element cooperating with the first counter-guide element to guide the slide in translation with respect to the housing along a first sliding direction, the first sliding direction being perpendicular to the axial direction, the two second radial guide elements being diametrically opposed with respect to the main axis of rotation and cooperating with the two second counter-guide elements to guide the orbital gear in translation with respect to the slide in a second sliding direction between a first end position and a second end position, the second sliding direction being perpendicular to the axial direction and to the first sliding direction.

In illustrative embodiments, the present disclosure increases the mechanism's resistance to impact, without increasing its mass or reducing its compactness. The present disclosure also aims to reduce the size and mass of the mechanism without reducing its mechanical strength in the event of impact.

In illustrative embodiments, the slide further comprises an additional second radial guide element having an additional contact surface and the orbital gear comprises an additional second counter-guide element having an additional counter-contact surface, the additional second radial guide element being substantially in contact with the additional second counter-guide element in the first end position.

The additional second radial guide element and the additional second counter-guide element create a mechanical weakening of the slide and/or orbital gear. However, a more uniform distribution of the forces exerted between the orbital gear and the slide can be achieved, thus providing greater mechanical strength for the adjustment mechanism.

For example, the adjustment mechanism further has the following features:
the additional second radial guide element is angularly offset by an additional (non-zero) guide angle about the main axis of rotation with respect to the second radial guide elements, and
the additional second counter-guide element is offset by the additional guide angle about the eccentric axis with respect to the second counter-guide elements.

The angular offset improves the mechanical strength of the adjustment mechanism, while keeping its dimensions and mass constant.

The additional guide angle is, for example, between 75 degrees and 105 degrees, or, for example, between 85 degrees and 95 degrees.

In various embodiments of the adjustment mechanism according to the disclosure, any of the following arrangements may further be employed:
the slide comprises two additional second radial guide elements, the two additional second radial guide elements are diametrically opposed about the main axis of rotation, and the orbital gear comprises two additional second counter-guide elements, the two additional second counter-guide elements are diametrically opposed about the eccentric axis;
the additional second counter-guide elements move away from the slide between 1 tenth of a millimeter and one millimeter in the first sliding direction, when the orbital gear moves away from the first end position and the second end position;
the additional counter-contact surface has teeth projecting toward the additional contact surface;
the teeth form projections of between 0.05 millimeters and 1 millimeter and are spaced from one another by between 0.5 millimeters and 2 millimeters;
the adjustment mechanism further comprises a motor configured to drive the eccentric device in rotation about the main axis of rotation;
the additional contact surface has a circular shape in cross-section perpendicular to the axial direction and the additional counter-contact surface has a complementary circular shape in cross-section perpendicular to the axial direction;
the additional second counter-guide element has a cross-section perpendicular to the axial direction which forms at least a half-disc with a flattened portion;
the additional second counter-guide element has a trapezoidal cross-section perpendicular to the axial direction.

The present disclosure further relates to a vehicle seat comprising the adjustment mechanism.

The vehicle seat, for example, comprises a base, a squab and the adjustment mechanism forms a raising mechanism configured to move the squab with respect to the base.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic view of a vehicle seat comprising an adjustment mechanism according to a first embodiment,

FIG. 2 is a view according to the arrow marked II in FIG. 1;

FIG. 3 is a perspective view of the adjustment mechanism;

FIG. 4 is an exploded perspective view of the adjustment mechanism;

FIG. 5 is a cross sectional view of the adjustment mechanism along the sectional plane marked V-V in FIG. 3;

FIG. 6 shows a cross sectional view of the adjustment mechanism along the sectional plane marked VI-VI in FIG. 5;

FIG. 7 is a view along the arrow marked VII in FIG. 6 of a slide and an orbital gear of the adjustment mechanism;

FIG. 8 shows, according to FIG. 7, a second example embodiment;

FIG. 9 shows a third example embodiment according to FIG. 7; and

FIG. 10 shows a fourth example embodiment according to FIG. 7.

### DETAILED DESCRIPTION

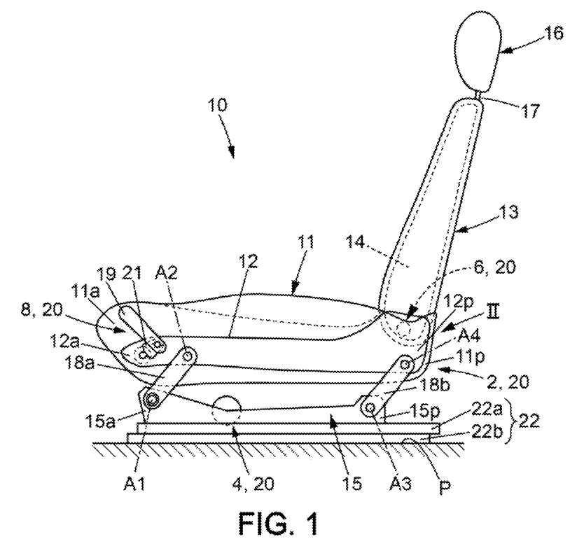

FIG. 1 schematically shows a vehicle seat 10 comprising a squab 11 with a squab frame 12, and a backrest 13 with a backrest frame 14, mounted on the squab frame 12. The squab frame 12 is mounted on a base 15 by means of an adjustment mechanism 20 forming a raising mechanism 2. A headrest 16 is connected to the backrest frame 14 by one or more headrest 16 attachment bushes or pins 17. The raising mechanism 2 may comprise at least a first connecting rod 18a and a second connecting rod 18b. For example, for each first connecting rod 18a and each second connecting rod 18b, the lower end is connected to the base 15 and the upper end is connected to the squab frame 12. More specifically, in the example shown, each first connecting rod 18a is pivotally mounted about a first transverse axis A1 on a front part 15a of the base 15 at one end and is pivotally mounted about a second transverse axis A2 with respect to a front part 12a of the squab frame 12 at an opposite end. Each second connecting rod 18b is pivotally mounted about a third transverse axis A3 on a rear part 15p of the base 15 and is pivotally mounted about a fourth transverse axis A4 on a rear part 12p of the squab frame 12 at an opposite end. In the example shown, the first transverse axis A1, the second transverse axis A2, the third transverse axis A3 and the fourth transverse axis A4 are parallel.

The squab frame 12 has a right side and a left side of similar architecture. In FIG. 1, only one side is shown. On the side not shown, the vehicle seat 10, for example, also has a first connecting rod 18a and a second connecting rod 18b connecting the squab frame 12 and the base 15 in a similar manner.

If needed, the squab 11 of the seat 10 can also be fitted with a squab front edge that can be moved in height and/or longitudinal extension. In the case of the tilting movement of the squab front edge, an auxiliary connecting rod 19 connects the squab frame 12 to the squab front edge, the auxiliary connecting rod 19 being movable by an adjustment mechanism 20 forming an auxiliary adjustment mechanism 8 via an auxiliary toothed sector 21.

In addition, the base 15 can be slid in relation to the floor P of the vehicle by means of longitudinal runners 22 comprising a fixed rail 22b attached to the floor P of the vehicle and a movable rail 22a secured to the base 15. The movable rail 22a can be moved with respect to the fixed rail 22b by means of an adjustment mechanism 20 forming a sliding mechanism 4.

The backrest 13 can be pivoted with respect to the squab 11, with the backrest frame 14 connected to the squab frame 12 via an adjustment mechanism 20 forming a hinge mechanism 6.

In the following, the adjustment mechanism 20 will be described only in relation to the raising mechanism 2, although it may form the sliding mechanism 4, the hinge mechanism 6, the auxiliary adjustment mechanism 8 or another similar adjustment mechanism.

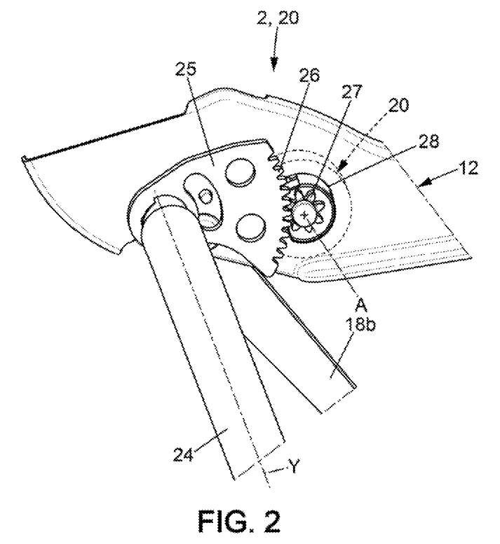

As shown in FIG. 2, the second connecting rod 18b is firmly connected to a transverse bar 24 connecting the second connecting rod 18b shown to a similar connecting rod on the other side of the squab 11 (not shown). In addition, the second connecting rod 18b is firmly connected to a control flange 25 in the form of a metal plate. The control flange 25 is directly connected to the transverse bar 24 and/or to the second connecting rod 18b. The control flange 25 includes a toothed sector 26 engaging directly with an output pinion 27. The output pinion 27 is mounted for rotation about a main axis of rotation A extending in an axial direction Y. The transverse bar 24 also extends along the axial direction Y.

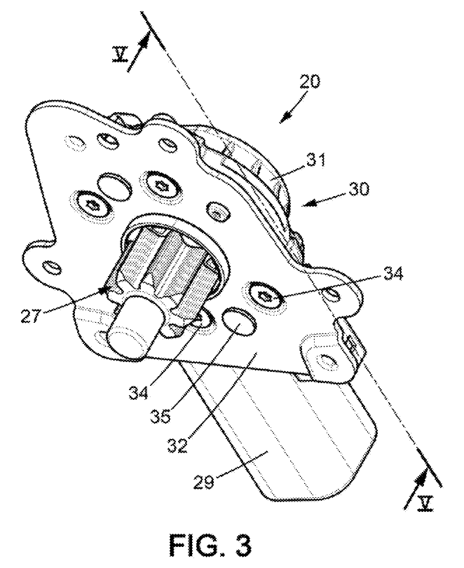

A first example of an adjustment mechanism 20, shown in greater detail in FIGS. 3 - 7, will now be described.

The adjustment mechanism 20 comprises, as shown in FIG. 3, a motor 29 and a housing 30. The housing 30 supports the motor 29 and is attached to the squab 11 of the vehicle seat 10. The housing 30 includes a casing 31 and a cover 32. The casing 31 and the cover 32 are fastened together, for example by means of fastening screws 34. Reinforcing elements 35 may also be provided between the casing 31 and the cover 32.

The casing 31 is bell- or bowl-shaped. The casing 31 comprises first counter-guide elements 52.

In the example shown, the casing 31 is formed of plastic material. Such plastic material may be ABS, polypropylene, polyethylene, polyamide, etc. However, the casing 31 could also be formed from metal, in particular an aluminum alloy, magnesium alloy or any lightweight metal alloy.

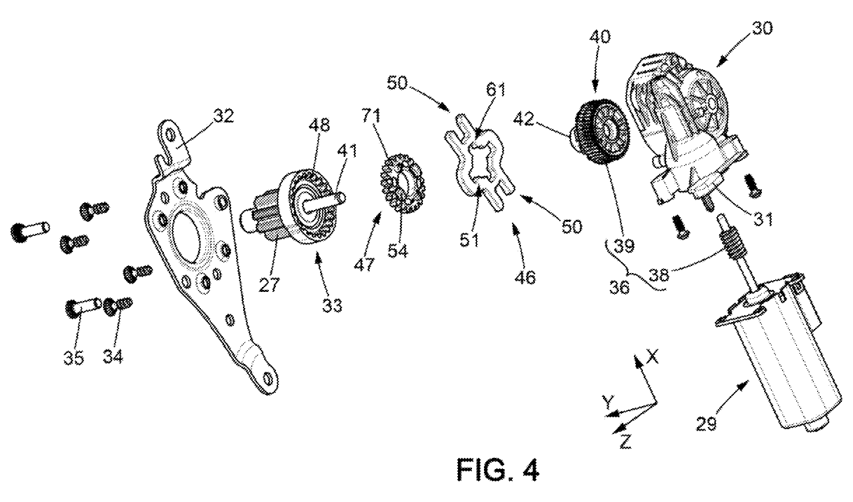

As shown in particular in FIG. 4, the adjustment mechanism 20 further comprises an eccentric device 40, an orbital gear 47, a slide 46 and an output device 33.

The motor 29 comprises a rotor extending perpendicularly to the axial direction Y. The end of the rotor carries a helical toothed screw (worm) 38. The helical toothed screw 38 extends inside the casing 31.

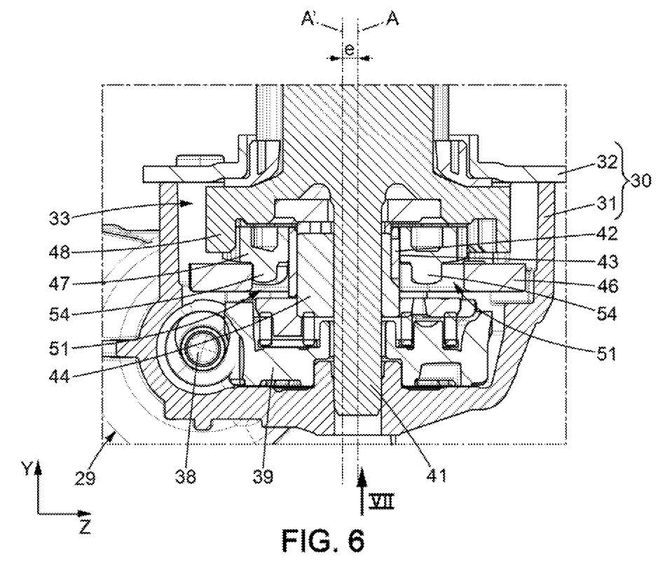

The eccentric device 40 is rotatably mounted about the main axis of rotation A in the housing 30. The eccentric device 40 essentially comprises an input element and an eccentric shaft 42. In the example shown, the input element is formed by an input wheel 39. The input wheel 39 is mounted rotatably about the main axis of rotation A in the housing 30. More specifically, the input wheel 39 is rotatably mounted on a main rotation shaft 41 carried by the housing 30. The input wheel 39 cooperates with the helical toothed screw 38 to form a reduction gearbox 36 and rotates at a lower speed than the rotor of the motor 29. The eccentric shaft 42 has an eccentric outer surface 43 extending along an eccentric axis A' and of circular cross-section. The eccentric axis A' extends in the axial direction Y. The eccentric axis A' is therefore parallel to the main axis of rotation A. The eccentric axis A' is spaced apart from the main axis of rotation A by an eccentric distance e, as shown in particular in FIG. 6.

In the example shown, the eccentric shaft 42 is secured to the input wheel 39 via a cam 44, so that it can rotate about the main axis of rotation A. The eccentric shaft 42 is tubular, with the cam 44 arranged inside the eccentric shaft 42. As a result, the eccentric shaft A' is rotated about the main axis of rotation A by the input wheel 39.

The orbital gear 47 is rotatably mounted about the eccentric axis A' on the eccentric outer surface 43 of the eccentric shaft 42.

In addition to the output pinion 27, the output device 33 comprises a toothed ring 48. The toothed ring 48 drives the output pinion 27 in rotation, the output pinion 27 being secured to the toothed ring 48. The output device 33 is guided in rotation about the main axis of rotation A with respect to the housing 30. In the embodiment shown, the output device 33 comprises the main rotation shaft 41. More specifically, the toothed ring 48, the output pinion 27 and the main rotation shaft 41 form a single one-piece element. A bearing can be arranged between the main rotation shaft 41 and the cover 32 to guide the rotation of the main rotation shaft 41 and more generally the output device 33 with respect to the housing 30.

The orbital gear 47 is externally toothed and the toothed ring 48 is internally toothed, so that the orbital gear 47 is received in the toothed ring 48. The orbital gear 47 has a smaller diameter and number of teeth than the toothed ring 48, in order to engage the latter and create a reduction ratio.

The orbital input wheel 47 comprises second counter-guide elements 54 and additional second radial guide elements 71, in order to lock the orbital gear 47 in rotation with respect to the housing 50 about the eccentric axis A' and allow only a circular translational movement of the orbital gear 47 about the main axis of rotation A.

More precisely, the orbital gear 47 comprises a pair of second counter-guide elements 54. The two second counter-guide elements 54 are diametrically opposed with respect to the eccentric axis A'.

The orbital gear 47 comprises a pair of additional second counter-guide elements 71. The two additional second counter-guide elements 71 are diametrically opposed about the eccentric axis A'.

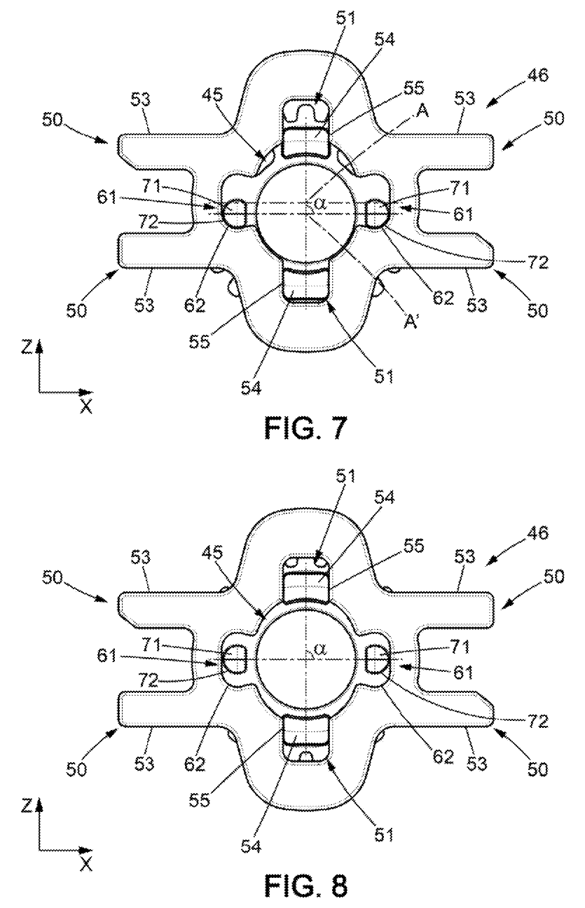

As shown in particular in FIG. 7, the additional second radial counter-guide elements 71 are offset about the eccentric axis A' with respect to the second counter-guide elements 54 by an additional guide angle α. The additional guide angle is between 75 degrees and 105 degrees, for example, between 85 degrees and 95 degrees, or, for example, substantially equal to 90 degrees.

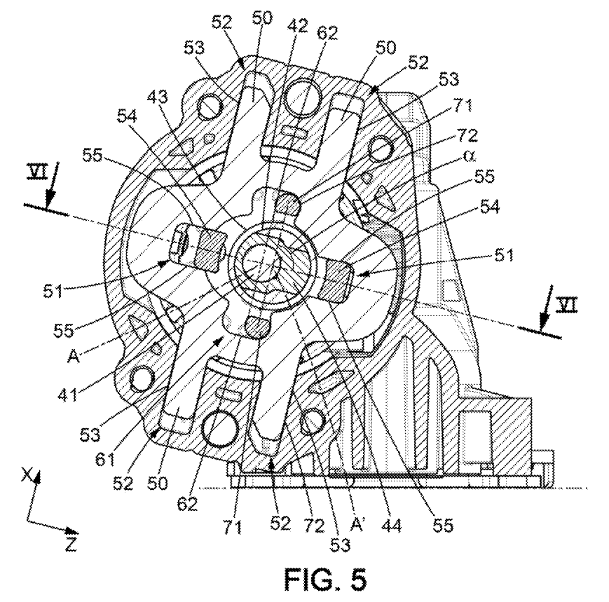

As shown in FIG. 5, the slide 46 comprises a main passage 45, at least one first radial guide element 50, second radial guide elements 51 and additional second radial guide elements 61.

The main passage 45 passes through the slide 46 in the axial direction Y. The cam 44 and eccentric shaft 42 extend through the main passage 45. For example, the main passage 45 is large enough so that the eccentric shaft 42 does not come into radial contact with the slide 46. However, the main passage 45 is as small as possible, in order to reduce the greater mechanical strength of the slide 46 as little as possible.

The first radial guide elements 50 cooperate with the first counter-guide elements 52 to guide the slide 46 in translation with respect to the housing 30 along a first sliding direction X. The first sliding direction X is perpendicular to the axial direction Y.

The first radial guide elements 50 comprise first guide surfaces 53 adapted to slide against the first counter-elements 52 so as to guide the slide 46 in translation along the first sliding direction X with respect to the housing 30.

For example, the first guide surfaces 53 can lock the slide 46 in translation with respect to the housing 30 in a second sliding direction Z, perpendicular to the first sliding direction X and to the axial direction Y. The slide 46 can also be locked against rotation about the main axis of rotation A with respect to the housing 30. Conversely, the slide 46 can (only) translate with respect to the housing 30 along the first sliding direction X.

In the example shown, the first radial guide elements 50 are each four in number and form two diametrically opposed pairs along the main axis of rotation A. Alternatively, a different number of first radial guide elements 50 could be provided, for example, an even number to form diametrically opposed pairs along the main axis of rotation A. The first counter-guide elements 52 are each four in number and form two pairs that are diametrically opposed along the main axis of rotation A. Alternatively, a different number of first counter-guide elements 52 could be provided, for example, an even number, to form diametrically opposed pairs along the main axis of rotation A.

The second radial guide elements 51 form a pair of diametrically opposed second radial guide elements 51 with respect to the main axis of rotation A. The second counter-guide elements 54 form a pair of diametrically opposed counter-guide elements 54 with respect to the eccentric axis A' on the orbital gear 47. The second radial guide elements 51 cooperate with the second counter-guide elements 54 to guide the orbital gear 47 in translation with respect to the slide 46 in the second sliding direction Z between a first end position (shown in FIG. 5) and a second end position. In this way, the orbital gear 47 can only move in the second sliding direction Z with respect to the slide 46.

The second guide surfaces 55 can, for example, lock the gear wheel 47 in translation with respect to the slide 46, along the first sliding direction X. The orbital gear 47 can also be locked against rotation about the eccentric axis A' with respect to the slide 46. The orbital gear 47, however, can (only) translate in the second sliding direction Z.

A complete turn of the orbital gear 47 in the toothed ring 48 angularly shifts the output pinion 27 with respect to the housing 31 by the difference in the number of teeth between the orbital gear 47 and the toothed ring 48.

In the first embodiment, each first radial guide element 50 can be formed by an extension of rectangular cross-section along the first sliding direction X from a body of the slide 46. The extensions can extend two by two on either side of the body of the slide 46. The extensions can thus be "U"-shaped, projecting with respect to the body of the slide 46 along the first sliding direction X and being diametrically opposed. The flanks of the extensions can then form the first guide surfaces 53. Each first counter-element 52 can then form a groove extending into the casing 31 of the housing 30, along the first sliding direction X and closely receiving the extensions.

Each second radial guide element 51 can be constituted by a rectilinear opening in the slide 46, extending along the second sliding direction Z and whose flanks form the second guide surfaces 55. Each second counter-guide element 54 may then comprise fingers of rectangular cross-section projecting from the orbital gear 47 along the axial direction Y and adapted to be closely received in the rectilinear openings. Each rectilinear opening can, for example, communicate with the main passage 45. In this case, for each pair of second radial guide elements 51 in the first end position and in the second end position of translation of the orbital gear 47 in the second sliding direction Z with respect to the slide 46, one of the second radial guide elements 51 is in the main passage 45, that is to say the second guide surface 55 is partially no longer guided by the flanks of the second radial guide element 51 in which it is received.

The additional second radial guide elements 61 form a pair of diametrically opposed additional second radial guide elements 61 with respect to the main axis of rotation A. The additional second counter-guide elements 71 form a pair of diametrically opposed counter-guide elements 71 with respect to the eccentric axis A' on the orbital gear 47. The additional second radial guide elements 61 each have an additional contact surface 62. The additional second guide elements 71 each have an additional counter-contact surface 72. In each of the end translational positions of the orbital gear 47 in the second sliding direction Z, the additional contact surfaces 62 come into contact with the additional counter-contact surfaces 72. Thus, the stresses applied between the orbital gear 47 and the slide 46 in the event of an impact on the vehicle or, more generally, on the adjustment mechanism 20, apply not only between the second radial guide elements 51 and the second counter-guide elements 54, but also between the additional second radial guide elements 61 and the additional second counter-guide elements 71.

The additional contact surfaces 62 have a circular shape in cross-section perpendicular to the axial direction Y, and the additional counter-contact surfaces 72 have a complementary circular shape in cross-section perpendicular to the axial direction Y.

It should be noted that the additional second counter-guide elements 71 are arranged on the orbital gear 47 at about the same distance (less than 5 millimeters apart, for example, less than 3 millimeters apart) from the eccentric axis A' as the second counter-guide elements 54, so that the overall dimensions of the adjustment mechanism are not increased and the mechanical strength of the slide 46 at the additional second radial guide elements 61 is increased.

Between the first end position (shown in FIG. 5) and the second end position of the orbital gear 47, the additional second counter-guide elements translate in the second sliding direction Z by twice the eccentric distance e.

Each additional second radial guide element 61 can be constituted by an additional opening in the slide 46, extending in the second sliding direction Z. In the first example, the additional opening forming the additional second radial guide element 61 communicates with the main passage 45.

Furthermore, each additional second counter-guide element 71 may then comprise additional fingers projecting from the orbital gear 47 along the axial direction Y. In the first example, the additional second radial guide elements 71 have a cross-section perpendicular to the axial direction that forms at least a half-disc with a flattened portion.

The second example shown in FIG. 8 differs essentially from the first example shown in FIGS. 3 - 7 in that the additional counter-contact surfaces 72 have teeth projecting toward the additional contact surfaces 62.

The teeth form projections of between 0.05 and 1 millimeter. The teeth are, for example, spaced between 0.5 and 2 millimeters apart. Additionally, the teeth, for example, form ribs extending in the axial direction Y.

At the distance between the first and second end translation positions of the orbital gear 47 with respect to the slide 46 in the second sliding direction Z, the additional second counter-guide elements 71 are, for example, between 1 tenth of a millimeter and one millimeter away from the slide 46 in the first sliding direction X. This prevents friction between the additional second radial guide elements 61 and the additional second counter-guide elements 71.

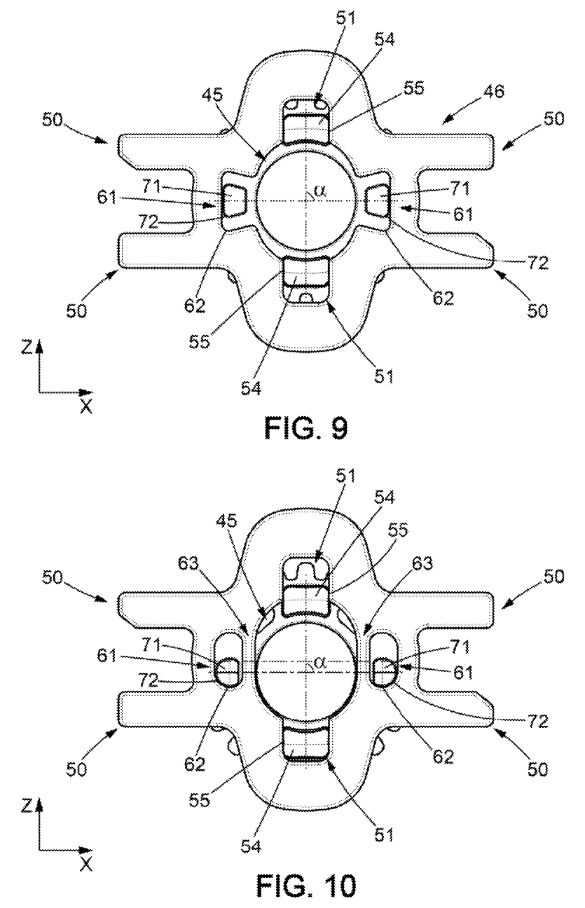

The third embodiment shown in FIG. 9 differs essentially from the first embodiment shown in FIGS. 3 - 7 in that the additional second radial guide elements have a trapezoidal cross-section perpendicular to the axial direction Y.

The fourth embodiment shown in FIG. 10 differs essentially from the first embodiment shown in FIGS. 3 - 7 in that each additional second radial guide element 61 consists of an additional opening in the slide 46, separated from the main passage by a bridge 63.

In the field of vehicle seats, it is useful to use a reducer to adjust the seat, in order to reduce the effort required from a user, or to reduce the adjustment speed and power required when an actuator is used.

For this purpose, an adjustment mechanism for a vehicle seat including:
a housing comprising a first counter-guide element,
an eccentric device rotatably mounted about a main axis of rotation in the housing, the main axis of rotation extending in an axial direction, the eccentric device comprises an eccentric shaft,
an orbital gear mounted on the eccentric shaft for rotation about an eccentric axis, the eccentric axis extending in the axial direction and being spaced from the main axis of rotation by a (non-zero) eccentricity distance, the orbital gear comprising two second counter-guide elements, the second counter-guide elements being diametrically opposed with respect to the eccentric axis,
an output device comprising a toothed ring which cooperates (meshes) with the orbital gear,
a slide comprising a first radial guide element and two second radial guide elements, the first radial guide element cooperating with the first counter-guide element to guide the slide in translation with respect to the housing along a first sliding direction, the first sliding direction being perpendicular to the axial direction, the two second radial guide elements being diametrically opposed with respect to the main axis of rotation and cooperating with the two second counter-guide elements to guide the orbital gear in translation with respect to the slide in a second sliding direction between a first end position and a second end position, the second sliding direction being perpendicular to the axial direction and to the first sliding direction.

Such a mechanism is fully satisfactory. However, the aim of the present disclosure is to increase the mechanism's resistance to impact, without increasing its mass or reducing its compactness. In fact, resistance could easily be increased by increasing the size of the mechanism. Conversely, the present disclosure aims to reduce the size and mass of the mechanism without reducing its mechanical strength in the event of impact.

To remedy the aforementioned challenges, according to the disclosure, the slide further comprises an additional second radial guide element having an additional contact surface and the orbital gear comprises an additional second counter-guide element having an additional counter-contact surface, the additional second radial guide element being substantially in contact with the additional second counter-guide element in the first end position.

The additional second radial guide element and the additional second counter-guide element create a mechanical weakening of the slide and/or orbital gear. However, a more uniform distribution of the forces exerted between the orbital gear and the slide can be achieved, thus providing greater mechanical strength for the adjustment mechanism.

For example, the adjustment mechanism further has the following features:
the additional second radial guide element is angularly offset by an additional (non-zero) guide angle about the main axis of rotation with respect to the second radial guide elements, and
the additional second counter-guide element is offset by the additional guide angle about the eccentric axis with respect to the second counter-guide elements.

The angular offset improves the mechanical strength of the adjustment mechanism, while keeping its dimensions and mass constant.

The additional guide angle is, for example, between 75 degrees and 105 degrees, or, for example, between 85 degrees and 95 degrees.

In various embodiments of the adjustment mechanism according to the disclosure, any of the following arrangements may further be employed:
the slide comprises two additional second radial guide elements, the two additional second radial guide elements are diametrically opposed about the main axis of rotation, and the orbital gear comprises two additional second counter-guide elements, the two additional second counter-guide elements are diametrically opposed about the eccentric axis;
the additional second counter-guide elements move away from the slide between 1 tenth of a millimeter and one millimeter in the first sliding direction, when the orbital gear moves away from the first end position and the second end position;
the additional counter-contact surface has teeth projecting toward the additional contact surface;
the teeth form projections of between 0.05 millimeters and 1 millimeter and are spaced from one another by between 0.5 millimeters and 2 millimeters;
the adjustment mechanism further comprises a motor configured to drive the eccentric device in rotation about the main axis of rotation;
the additional contact surface has a circular shape in cross-section perpendicular to the axial direction and the additional counter-contact surface has a complementary circular shape in cross-section perpendicular to the axial direction;
the additional second counter-guide element has a cross-section perpendicular to the axial direction which forms at least a half-disc with a flattened portion;
the additional second counter-guide element has a trapezoidal cross-section perpendicular to the axial direction.

The present disclosure further relates to a vehicle seat comprising the adjustment mechanism.

The vehicle seat, for example, comprises a base, a squab and the adjustment mechanism forms a raising mechanism configured to move the squab with respect to the base.

1. An adjustment mechanism for a vehicle seat including:
a housing comprising a first counter-guide element,
an eccentric device rotatably mounted about a main axis of rotation in the housing, the main axis of rotation extending in an axial direction, the eccentric device comprises an eccentric shaft,
an orbital gear mounted on the eccentric shaft for rotation about an eccentric axis, the eccentric axis extending in the axial direction and being spaced from the main axis of rotation by an eccentricity distance, the orbital gear comprising two second counter-guide elements, the second counter-guide elements being diametrically opposed with respect to the eccentric axis,
an output device comprising a toothed ring which cooperates with the orbital gear,
a slide comprising a first radial guide element and two second radial guide elements, the first radial guide element cooperating with the first counter-guide element to guide the slide in translation with respect to the housing along a first sliding direction, the first sliding direction being perpendicular to the axial direction, the two second radial guide elements being diametrically opposed with respect to the main axis of rotation and cooperating with the two second counter-guide elements to guide the orbital gear in translation with respect to the slide in a second sliding direction between a first end position and a second end position, the second sliding direction being perpendicular to the axial direction and to the first sliding direction,
wherein the slide further comprises an additional second radial guide element having an additional contact surface and the orbital gear comprises an additional second counter-guide element having an additional counter-contact surface, the additional second radial guide element being substantially in contact with the additional second counter-guide element in the first end position.

2. The adjustment mechanism according to claim 1, wherein:
the additional second radial guide element is angularly offset by an additional guide angle about the main axis of rotation with respect to the second radial guide elements, and
the additional second counter-guide element is offset by the additional guide angle about the eccentric axis with respect to the second counter-guide elements.

3. The adjustment mechanism according to claim 2, wherein the additional guide angle is between 75 degrees and 105 degrees.

4. The adjustment mechanism according to claim 1, wherein:
the slide comprises two additional second radial guide elements, the two additional second radial guide elements are diametrically opposed about the main axis of rotation, and
the orbital gear comprises two additional second counter-guide elements, the two additional second counter-guide elements are diametrically opposed about the eccentric axis.

5. The adjustment mechanism according to claim 4, wherein the additional second counter-guide elements move away from the slide between 1/10 of a millimeter and one millimeter in the first sliding direction, when the orbital gear moves away from the first end position and the second end position.

6. The adjustment mechanism according to claim 1, wherein the additional counter-contact surface has teeth projecting toward the additional contact surface.

7. The adjustment mechanism according to claim 6, wherein the teeth form projections of between 0.05 millimeters and 1 millimeter and are spaced from one another by between 0.5 millimeters and 2 millimeters.

8. The adjustment mechanism according to claim 1, wherein the adjustment mechanism comprises a motor configured to drive the eccentric device in rotation about the main axis of rotation.

9. The adjustment mechanism according to claim 1, wherein the additional contact surface has a circular shape in cross-section perpendicular to the axial direction and the additional counter-contact surface has a complementary circular shape in cross-section perpendicular to the axial direction.

10. A vehicle seat comprising the adjustment mechanism according to claim 1.
